(19) United States
(12) Patent Application Publication
(10) Pub. No.: US 2005/0233114 A1
(43) Pub. Date: Oct. 20, 2005

(54) Grip tape for golf club

(76) Inventor: Tien-Jui Chi, Taipei (TW)

Correspondence Address: Tien-Jui CHI, P.O. Box No. 6-57, Junghe, Taipei, 235, TW

(21) Appl. No.: 10/825,227

(22) Filed: Apr. 16, 2004

(51) Int. Cl. B32B 3/00

(52) U.S. Cl. 428/156; 428/172

(57) ABSTRACT

A grip tape for a golf club is disclosed. The grip tape for an elastic sleeve of the golf club includes a strip made from a shockproof material and having two long side peeled into a specific thickness and a top surface with a fiber layer; and an adhesive layer disposed between the elastic sleeve and the strip for making the strip being wound around the elastic sleeve spirally, wherein the fiber layer further provides the function of slidproof.

### FIELD OF THE INVENTION

The present invention is related to a grip tape and more especially, to a grip tape for a golf club.

### BACKGROUND OF THE INVENTION

Golf is one of popular ball games. For bringing skill into full play, there should be a good golf club for operating in coordination, besides playing skill. Since the state of art depends on the state of your tool, if a good golf club is selected, we will be able to bring our skill into full play.

When we are playing golf, our hands will sweat greatly due to the motion of body. The sweat of user's hand usually causes the shakiness and runaway of the golf club. Furthermore, because of the perspiration of hand, the golf club could be thrown out and injure other people. On the other hand, the golf club without a good handle is harmful for users over a long period of time. Therefore, it is necessary to design a handle being capable of protecting the hand of the player.

Thus a device for buffering between the hands and the gold club is necessary. Usually, the golf club has several methods of protecting the handle. For example, a rubber injection molding is introduced to that. In particular, the elastic rubber is preferably made of ethylene-propylene-diene terpolymer (EPDM) with features of ozone resistance, high weathering durability, heat-resistantance, durable performance and electrical insulation. Besides, cotton yarn and polyurethane (PU) wound strips are also applied. Each method provides a handle with a specific sense of touch and features, and is used by a variety of players. Meanwhile the handle with cotton yarn for protecting makes players feel comfortable with slide proof function, suitable for use in Asia or moist areas. However, the material of such kind of handles is harmful for hands of the player. It will cause hands of players callus and hurt hands of players in the long run.

Please refer to FIG. 1. It discloses a wound strip for a handle of a prior art. The wound strip is a long strip 2 with two sides 12, 12′ peeled into a specific thickness and disposed below the bottom 11 thereof, and two ends 13 thereof are sharpened gradually. One of the ends 13 of the strip 2 is spirally wound from the bottom end 21 thereby till the strip 2 being completely wound around the handle 20, wherein the latter of the strip 2 closely overlaps on the former thereof. However the strip 2 is easy to get off. Because the strip 2 is wound by means of overlapping, the latter of the strip 2 and the former wound strip 2 should overlap on the overlapping place 15. Although two sides 12, 12′ have been peeled, the thickness of the overlapping place 15 is still thicker than that of the former wound strip 2, and there should be an uneven surface. No matter how firmly the strip is wound, the uneven surface and the overlapping place 15 will be extruded and come off while the players are holding and wielding the handle. Regardless of tightness of the wound strip, there should be a seam 16. Hence, the overlapping place is easy to be stirred up from the seam 16. The player holding the handle will feel uncomfortable and moreover the handle with the strip will be harmful for a long time. On the other hand, the sweat will dip into the seam 16, and then the strip 2 will be unwound and peeled off. Thereby the use life of the strip is decreased and the player has to change another one.

Please refer to FIG. 2. It discloses another strip according to a prior art. As shown in FIG. 2, the strip 30 has two long sides 32, 32′ peeled into half thickness. One side 32 of the strip 30 is pressured to form a narrow side 321 via a hot-pressure process, and another side 32′ is pressured to form a wide side 321′via the hot-pressure process. Furthermore, the side 32 is cut a part to form two bevel edges 322 on two ends 34 of the strip 30. One of the ends 34 with bevel edge 322 of the strip 2 is aligned to the bottom edge 21 of the handle 20 and is wound spirally from bottom edge 21 thereby until the strip 30 being completely wound around the handle 20. The latter part of the strip 2 closely overlaps on the former part thereof and then the wide side 321′ is covered on the top of the strip 30. Meanwhile the wide side 321′ and the narrow side 321 are corresponding to each other and the later narrow side 321 is overlapped the former wide side 321. Accordingly, the strip 30 is completely wound around the handle until the strips is wound to the top of the handle 20 finally. Usually, the strip 30 is a multi-layer structure made from polyurethane (PU) film, PU foam film, non-woven film or ethylene vinyl acetate (EVA) foam. In practice, two pretreatment of hot-pressure process should be executed for manufacturing the strip 30 of the above descriptions. Moreover, the strip 30 is difficult to be wound around the handle because of the multi-layer structure thereof. Furthermore, the multi-layer structure makes the manufacturing process more complicated.

Therefore, it is necessary to rectify those drawbacks and provide a new grip tape for a golf club by the present applicant, wherein the grip tape is compact, shockproof, skid-proof and durable.

### SUMMARY OF THE INVENTION

It is therefore a primary objective of the present invention to provide a grip tape for a golf club whose structure is simple with functions of shock-resistance, slid-proofness, good touch, durableness, compactness and beautiful appearance. The present invention is composed of an anti-shock layer made of light-weighted material for buffering the shock, a fabric layer covered on top of the anti-shock layer for absorbing sweat, and an ant-sliding layer disposed on part of the fabric layer for the convenience of holding.

It is therefore a further objective of the present invention to provide a grip tape for a golf club whose structure is a long strip. The present invention features on that the grip tape is made from light-weighted material with shockproof function. The two sides of the bottom of the grip tape are peeled into a certain thickness and the surface of the grip tape is covered with a fabric layer having skidproof patterns for absorbing sweat and anti-sliding.

It is therefore another objective of the present invention to provide a long grip tape for a golf club. The strip is composed of a anti-shock layer, a fabric layer with anti-sliding patterns covered on top of the anti-shock layer.

### BRIEF DESCRIPTION OF THE DRAWING

FIG. 1(a)-1(b)-1(c) illustrate a wound strip for a golf handle in accordance with a prior art;

FIG. 2(a)-2(b)-2(c) illustrate another wound strip for a golf handle according to the prior art; and

FIG. 3(a)-3(b) illustrate a wound strip for a golf handle the present invention.

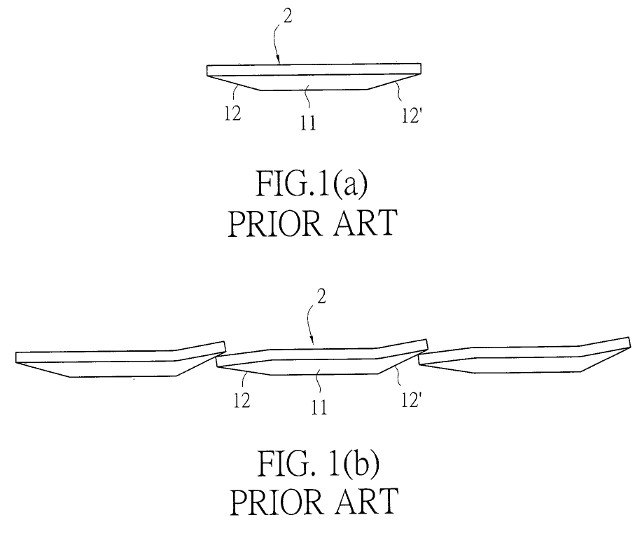

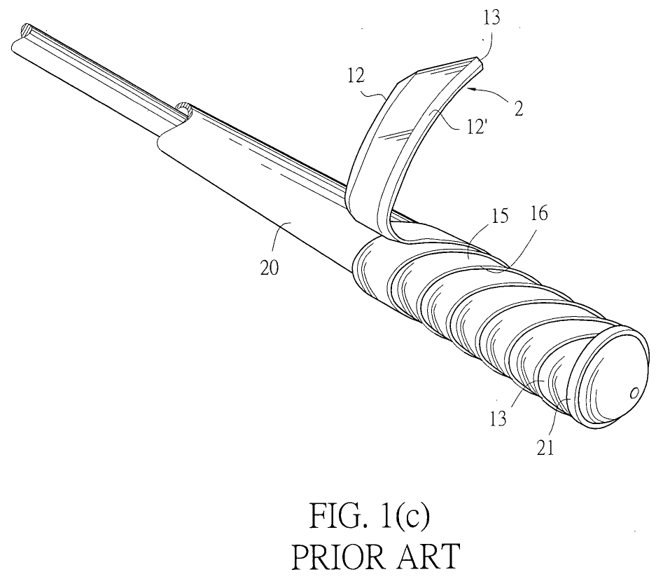

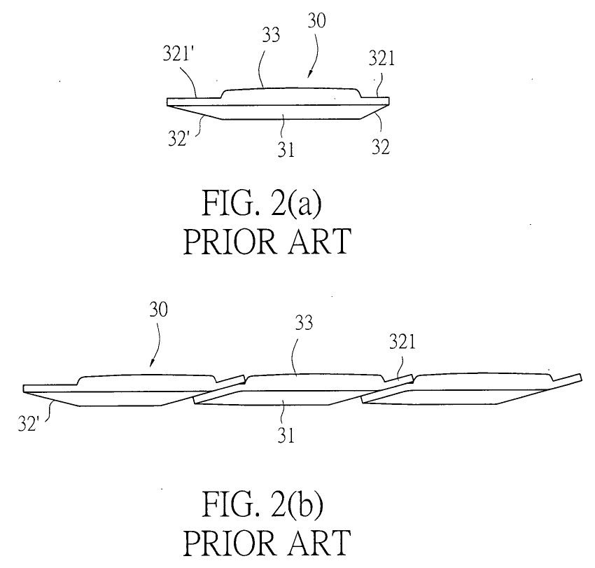

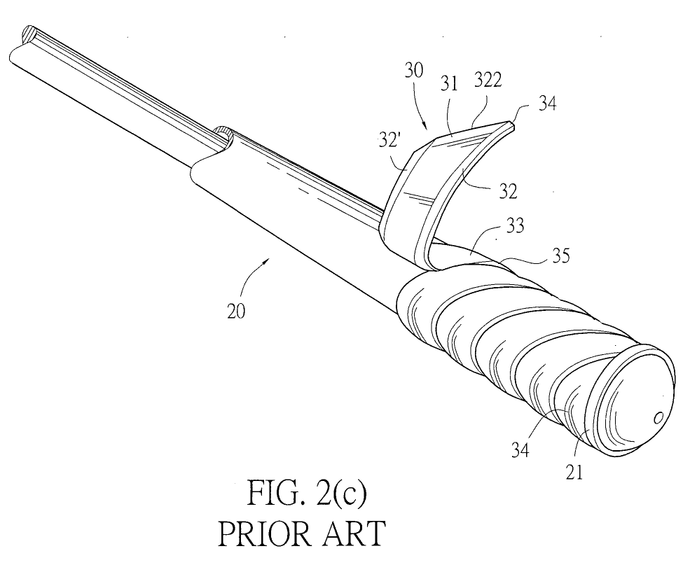

### DETAILED DESCRIPTION OF THE PREFERRED EMBODIMENTS

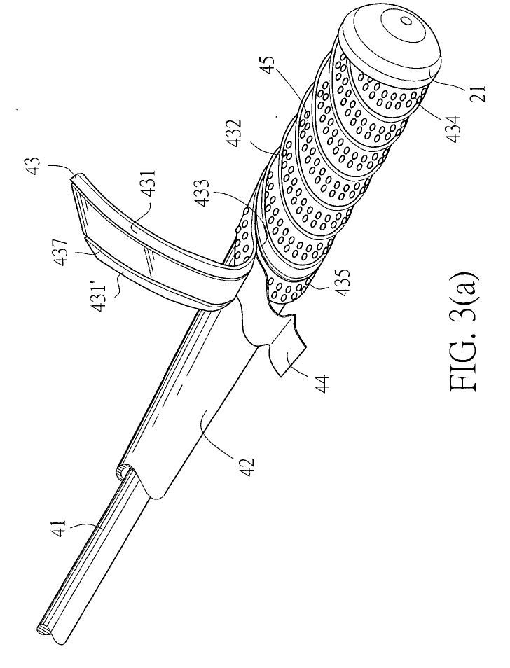

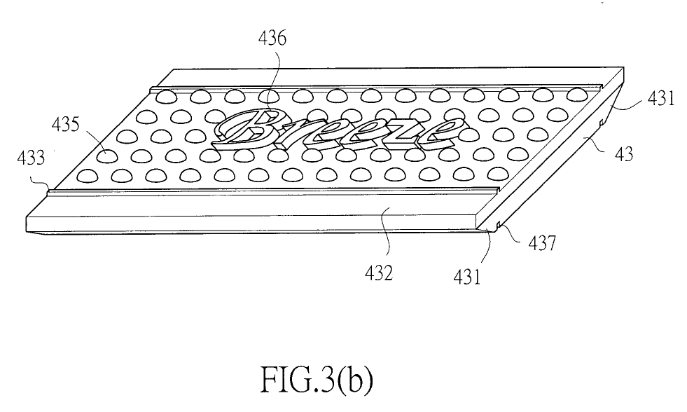

Refer to FIGS. 3(a) & 3(b), the present invention is wound on an elastic sleeve 42 of a golf club 41. A grip tape according to the present invention is composed of a lightweight long strip 43 made from shockproof material having two long side 431-431′ peeled into a specific thickness and a top surface with a fabric layer 432, and an adhesive layer 44 disposed between the elastic sleeve 42 and the long strip 43. The fiber layer 432 is further arranged with anti-slip rib 435 for convenience of being held. The adhesive layer 44 is used to make the strip 43 be wound around the elastic sleeve 42 spirally.

When users want to wind the strip 43 around the elastic sleeve 42, the side 431 with a sharp-cut end 434 should be aligned to the bottom edge 21 of the elastic sleeve 42, and then the strip 43 could be wound around the elastic sleeve 42. Meanwhile the latter of the strip 43 closely overlaps on the former thereof and the side 431′ is positioned on the top of the long side 431. The wide side 431′ and the narrow side 431 are corresponding to each other and the later side 431 is overlapped and adhered on the former side 431′ by the adhesive layer 44. Accordingly, the strip 43 is completely wound around the elastic sleeve 42 until the strip 43 is wound to the top of the elastic sleeve 42 finally.

In practice, the strip 43 is fine foam made from polymerization of styrene-like and ethylene monomer under high-temperature high-pressure through vulcanization, wherein the foamy layer is one-layer structure (thermo plastic damping) with damping function. The fabric layer 432 is a fiber layer or a micro-fiber layer that is capable of adsorbing sweat and is agglutinated on the surface of the strip 43 by rolling. The anti-slip rib 435 made from silicon is disposed on the strip 43 by screen printing, jet printing or printing in dotted pattern, figures or logos, so as to increase the friction of the surface thereof and prevent the sliding. The fabric layer 432 further having an aligned pattern 433 for the strip 43 aligning to the elastic sleeve 42 of the golf club 41 or the alignment of the adhesive layer 44 to the border thereof. Refer to FIG. 3(b), the aligning pattern 433 can be a rib (435), and a corresponding jog 437 is disposed on the bottom side of the strip 43 so as to make the adhesion of the strip 43 with the golf club 41 more firmly and easily. Moreover, a special pattern 436 is positioned on the fabric layer 432 for labeling or demonstration of logos. The special pattern 436 also has the function of slip proof.

Refer to FIG. 3(a) & FIG. 3(b), another embodiment is disclosed. The grip tape includes an anti-shock layer 43 made from light-weight shockproof material as a damper, a fabric layer 432 covered on top of the anti-shock layer 43 for adsorbing sweat; and an anti-slip layer 435 arranged on top of part of the fabric layer 432, forming a ragged surface for the convenience of holding.

In practice, the anti-shock layer 43 is composed by Styrene-Ethylene/Butylene-Styrene (SEBS) Copolymer, made from the polymerization of polystyrene-like and styrene monomer under high pressure and high temperature (through vulcanization). The two long sides 431-431′ of the bottom of the anti-shock layer 43 are peeled into a specific thickness. The fabric layer 432 is a fiber layer or a micro-fiber layer, being adhered on the surface of the anti-shock layer 43. The anti-slip rib 435 made from silicon is partially coated on the fabric layer 432 by screen printing. In this embodiment, the anti-slip rib 435 is made of a plurality of embossed frame. In FIG. 3(b), the anti-slip rib 435 can also be a special pattern. The grip tape further includes an adhesive layer 44, a double-sided tape, positioned on the bottom of the anti-shock layer 43 for winding the grip tape around the elastic sleeve 42 spirally. The fabric layer 432 further having an aligned pattern 433 for the anti-shock layer 43 aligning to the elastic sleeve 42 of the golf club 41 or the alignment of the adhesive layer 44, a double-sided tape, to the border thereof, as shown in FIG. 3(b). The aligned pattern 433 is a rib while a corresponding nick 437 is disposed on the corresponding position on the bottom of the anti-shock layer 43 for affixing the grip tape on the golf club firmly and properly.

The hardness of the anti-shock layer 43 ranged from SHORE C 35 degrees to 45 degrees and the width thereof is from 2 cm to 2.4 cm, it's also the width of the grip tape. The width of the anti-slip layer is from 1 cm to 2 cm. The grip tape 43 can also be processed to add a plurality of vertical air channels, or engraved patterns (not shown in figures).

In summary, the present invention provides a lightweight, high-quality gripe tape for a gold club with functions of damping, sweating out and anti-sliding. Due to the simplicity of the structure, the present invention is easy to be assembled.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims, which are to be accorded with the broadest interpretation so as to encompass all such modifications and similar structures.

1. A grip tape for a golf club, comprising:
a shockproof layer made from light-weighted material for buffering shock of stroke;
a fabric layer covered on top of the shockproof layer for adsorbing sweat, and a anti-sliding layer disposed on part of the fabric layer, together forming a ragged surface for the convenience of holding.

2. The grip tape as claimed in claim 1, wherein the shockproof layer is fine foam made from polymerization of styrene-like and ethylene monomer under high-temperature high-pressure through vulcanization.

3. The grip tape as claimed in claim 1, wherein the shockproof layer is composed by Styrene-Ethylene/Butylene-Styrene (SEBS) Copolymer.

4. The grip tape as claimed in claim 1, wherein the shockproof layer having two long sides peeled into a specific thickness.

5. The grip tape as claimed in claim 1, wherein the fabric layer is a fiber layer or a micro-fiber layer.

6. The grip tape as claimed in claim 1, wherein the fabric layer is agglutinated on the surface of the shockproof layer by rolling.

7. The grip tape as claimed in claim 1, wherein the anti-sliding layer is made from silicon.

8. The grip tape as claimed in claim 7, wherein the anti-sliding layer is partially coated on the fabric layer by screen printing.

9. The grip tape as claimed in claim 8, wherein the anti-sliding layer having a plurality of embossed frame.

10. The grip tape as claimed in claim 8, wherein the anti-sliding layer further having a special embossed pattern.

11. The grip tape as claimed in claim 1, wherein the grip tape further having an adhesive layer for making the grip tape being wound around an elastic sleeve of a golf club spirally.

12. The grip tape as claimed in claim 1, wherein the adhesive layer is a double-sided tape.

13. A gripe tape for a golf club is characterized in that: a long strip is made from a shockproof light-weighted material for buffering the shock, two sides on the bottom thereof peeled into a specific thickness, a fabric layer covered on the surface thereof for absorbing sweat, wherein an anti-slip rib is disposed on the fabric layer.

14. The grip tape as claimed in claim 13, wherein the shockproof light-weighted material is fine foam made from polymerization of styrene-like and ethylene monomer under high-temperature high-pressure through vulcanization.

15. The grip tape as claimed in claim 13, wherein the shockproof light-weighted material is Styrene-Ethylene/Butylene-Styrene (SEBS) Copolymer.

16. The grip tape as claimed in claim 13, wherein the long strip is wound around an elastic sleeve of a golf club spirally by a double-sided tape.

17. The grip tape as claimed in claim 13, wherein the anti-slip rib further having an aligned nick for the alignment of the strip on an elastic sleeve of a golf club.

18. The grip tape as claimed in claim 13, wherein the fabric layer is agglutinated on the surface of the long strip by rolling.

19. The grip tape as claimed in claim 13, wherein the fabric layer is a fiber layer or a micro-fiber layer.

20. The grip tape as claimed in claim 13, wherein the anti-slip rib is made from silicon.

21. The grip tape as claimed in claim 20, wherein the anti-slip rib is partially coated on the fabric layer by screen printing.

22. The grip tape as claimed in claim 21, wherein the anti-slip rib having a plurality of embossed frame.

23. A long gripe tape for a golf club comprising:
a shockproof layer made from shockproof light-weighted material for buffering shock of stroke, and a fabric layer covered on top of the shockproof layer for adsorbing sweat, wherein the fabric layer further having an anti-slip rib disposed on part of the surface thereof for convenience of holding.

24. The long gripe tape for a golf club as claimed in claim 23, wherein the shockproof layer is a thermo plastic layer with damping function.

25. The long gripe tape for a golf club as claimed in claim 23, wherein the shockproof layer is fine foam made from polymerization of styrene-like and ethylene monomer under high-temperature high-pressure through vulcanization.

26. The long gripe tape for a golf club as claimed in claim 23, wherein the shockproof layer is Styrene-Ethylene/Butylene-Styrene (SEBS) copolymer.

27. The long gripe tape for a golf club as claimed in claim 23, wherein the long grip tape further having an adhesive layer disposed on bottom side thereof for making the grip tape being wound around an elastic sleeve of a golf club spirally.

28. The long gripe tape for a golf club as claimed in claim 23, wherein the anti-slip rib further having a special pattern for labeling.

29. The long gripe tape for a golf club as claimed in claim 23, wherein the fabric layer is agglutinated on the surface of the shockproof layer by rolling.

30. The long gripe tape for a golf club as claimed in claim 23,wherein the fabric layer is a fiber layer or a micro-fiber layer.

31. The long gripe tape for a golf club as claimed in claim 23, wherein the anti-slip rib is made from silicon.

32. The long gripe tape for a golf club as claimed in claim 31, wherein the anti-slip rib is partially coated on the fabric layer by screen printing.

33. The long gripe tape for a golf club as claimed in claim 32, wherein the anti-slip rib having a plurality of embossed frame.

34. The long gripe tape for a golf club as claimed in claim 23, wherein the hardness of the shockproof layer ranges from the SHORE C 35 degrees to 45 degrees.

35. The long gripe tape for a golf club as claimed in claim 23, wherein the width of the shockproof layer is from 2.2 cm to 2.4 cm.

36. The long gripe tape for a golf club as claimed in claim 35, wherein the anti-slip rib is from 1 cm to 2 cm.
